(19) United States
(12) Patent Application Publication
(10) Pub. No.: US 2009/0215416 A1
(43) Pub. Date: Aug. 27, 2009

(54) System and Method for Providing Information About Broadcasted Content

(76) Inventor: Harry Lee Devore, Larchmont, NY (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/392,633

(22) Filed: Feb. 25, 2009

Related U.S. Application Data
(60) Provisional application No. 61/031,037, filed on Feb. 25, 2008.

(51) Int. Cl. H04B 1/18

(52) U.S. Cl. 455/185.1

(57) ABSTRACT

A system and method for providing information about broadcasted content is provided. A synchronization server receives requests for information about content being broadcasted, such as a song being broadcasted by a radio station. The request can be issued by a listener of the radio station using his or her cellular telephone, a portable communications device, or a local computer. The time of the request is used to query a database of a music server associated with the radio station, to retrieve song title, artist name, and album name corresponding to the song currently being played by the radio station. Information about the song is then transmitted to the listener, whereupon the user can perform other tasks associated with the song, such as obtaining lyrics to the song, ordering tickets to events by the artist of the song, downloading ring tones, downloading the song, accessing a streamed version of the song, etc.

### RELATED APPLICATIONS

This application claims the benefit of U.S. Provisional Patent Application Ser. No. 61/031,037 filed Feb. 25, 2008, the entire disclosure of which is expressly incorporated herein by reference.

### BACKGROUND OF THE INVENTION

1. Field of the Invention

The present invention relates to streaming or broadcasted content, such as radio broadcasts. More specifically, the present invention relates to a system and method for providing information about broadcasted content.

2. Related Art

When users hear broadcasted content (such as a song being played by a radio station), they often want to know more about the content being broadcasted. For example, a person listening to a song being played on a radio station may want to know the song name, artist name, and album title corresponding to the song. Often, listeners have to rely on the broadcaster to orally convey this information after the song has been played. Unfortunately, with large blocks of uninterrupted music played on some stations, the listener is forced to listen to a long block of music before the information about a particular song is given. Sometimes, information is provided before a song is played, and a listener cannot acquire such information if the listener tunes into the broadcast after the information is provided. Also, broadcasters occasionally do not give information about songs, and the listener is thus left uninformed.

The Radio Data System (RDS) is a known technology which provides information about broadcasted content (such as a song title and artist information) on the display of a radio receiver (e.g., car stereo) as the content is being broadcasted. The RDS signal is provided by a broadcaster's transmitting equipment, and is decoded by the radio to display song and artist information. While this technology provides information about content to the listener, an RDS-capable radio is required to receive and decode the RDS signal. As such, a listener must purchase specific equipment, which may not be desirable or feasible for all listeners.

Some radio stations provide websites which allow a listener to view information about a song currently being broadcasted by the radio station. While such a feature also provides the listener with information about a song, the listener must know the specific Internet (URL) address for the radio station, and must navigate the radio station's website to obtain the desired information, which can be time consuming.

### SUMMARY OF THE INVENTION

The present invention relates to a system and method for providing information about broadcasted content. A synchronization server is provided for receiving requests for information about content being broadcasted, such as a song being broadcasted by a radio station. The request can be issued by a listener of the radio station using his or her cellular telephone, a portable communications device, or a local computer. The request is timestamped, and the timestamp is used to query a database of a music server associated with the radio station, to retrieve song title, artist name, and album name corresponding to the song currently being played by the radio station. In response to the request, information is provided to the user's cellular telephone or portable communications device, which contains the song title, artist name, and album name. Optionally, the synchronization server could “tag” the song by storing information about the song in an account created at the synchronization server, for later access by the listener. Information about the song is then transmitted to the listener by way of a web page, whereupon the user can perform other tasks associated with the song, such as obtaining lyrics to the song, ordering tickets to events by the artist of the song, downloading ring tones, downloading the song, accessing a streamed version of the song, etc.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing hardware components of the present invention;

FIG. 2 is a flowchart showing processing steps according to the present invention for providing information about broadcasted content in response to a telephone call by a listener;

FIG. 3 is a flowchart showing processing steps according to the present invention for providing information about broadcasted content in response to a web-based query by a listener; and

FIGS. 4-6 are screenshots showing user interface screens generated by the present invention for allowing a listener to obtain information about content using a web-based interface.

### DETAILED DESCRIPTION OF THE INVENTION

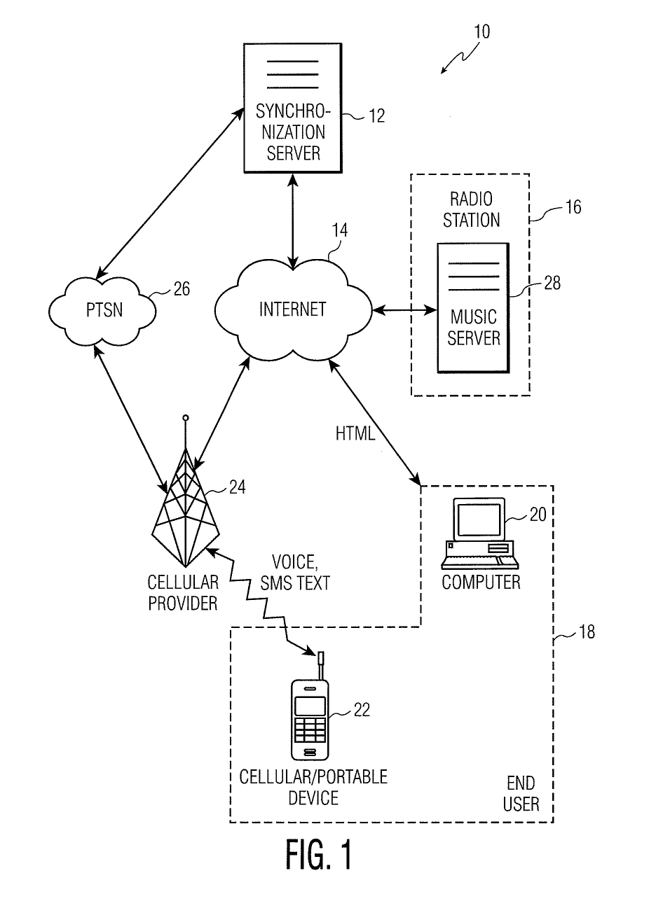

The present invention relates to a system and method for providing information about broadcasted content, described in detail below in connection with FIGS. 1-6. By the term “content,” it is meant any type of information broadcasted to one or more recipients by a broadcasting entity, such as a song broadcasted by a radio station, video content (shows, advertisements, etc.) broadcasted by a television station, an advertisement broadcasted by a radio station or television station, etc.

FIG. 1 is a diagram showing hardware components of the present invention, indicated generally at 10. The present invention comprises a synchronization server 12 which receives telephonic and/or web-based requests for information about content broadcasted by a radio station 16, and processes same to provide requested information about content. Such requests can be issued by a listener 18 of the radio station 16, using a cellular telephone and/or portable computing device 22 or a computer 20 in communication with the Internet 14. The synchronization server 12 could include an enterprise-level server manufactured by IBM or other company, with 8 gigabytes of random access memory (RAM), 200 gigabytes of disk storage space, running the Windows Enterprise Server 2003 operating system, and having associated network communications equipment for allowing connection of the server to a public telephone switched network (PTSN) 26 and/or the Internet 14.

The cellular telephone/portable communications device 22 is in communication with the synchronization server 12 via a cellular provider's wireless network 24 (which, for example, could provide voice and Short Messaging Service (SMS) text data service for the device 22. The cellular provider's wireless network 24 could communicate with the server 12 using the PTSN 26, or using the Internet 14. If a request for information about content is provided by way of the computer 20, communication with the server 12 could be by way of hypertext markup language (HTML) pages provided to the computer 20 by the server 12, through the Internet 14.

The server 12 is also in communication with a music server 28 associated with the radio station 16. The music server 28 stores information about content being broadcasted by the radio station 16, such as song title, artist name, and album title. The music server 28 could be located at the radio station 16, or elsewhere. As discussed in detail below, the synchronization server 12 receives a request for information about content, such as a request for a song title, artist name, or album title of a song currently being broadcast by the radio station 16. The request could be issued telephonically by the user 18 calling a telephone number associated with the radio station 16, which establishes a connection between the synchronization server 12 using the cellular/portable communications device 22 (e.g., the synchronization server 12 could be located at the radio station 16, and connected to the radio station's telephone connection, or it could be located at a central location and a telephone call to the radio station 16 could be routed to the server 12). Thus, when a person listening to a song being played by the radio station 16 desires to receive information about the song, the person could call the telephone number associated with the radio station 16, whereupon the synchronization server 12 provides the requested information to the caller by way of a voice response (e.g., using Interactive Voice Response (IVR) software), or by way of a text message which is sent to the cellular/portable communication device 22. Also, the user 18 could visit a website associated with the radio station 16 and could issue a request for information about a song currently being played by the radio station 16. In such circumstances, the server 12 handles the web-based request, and provides the requested information about the song to the user 18 via the web. The server 12 timestamps each request for information about content (whether the request is issued telephonically via the cellular/portable device 22 or via the web using the computer 20), and uses the timestamp information to retrieve matching information from the music server 28 for subsequent processing by the server 12 and transmission to the user 18.

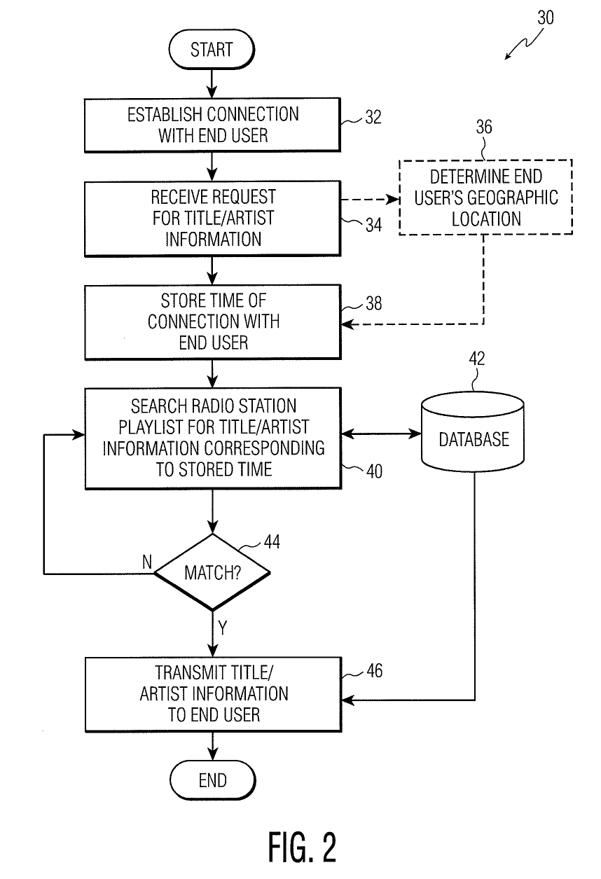

FIG. 2 is a flowchart showing processing steps, indicated generally at 30, according to the present invention for handling requests for information about content. The processing steps 30 could be embodied as one or more software programs/modules which are programmed into and executed by the synchronization server 12 of FIG. 1. Such programs/modules could be written in any suitable programming and/or scripting language, such as Java, PHP, MySQL, Lotus Domino, AJAX, HTML and others. Beginning in step 32, a connection is established with an end user. As discussed above, the connection could be between a cellular telephone/portable communications device operated by the user, through a cellular telephone network, or between a user's local computer, through the Internet. In step 34, the server 12 receives a request for information about content being broadcasted by the radio station 16, such as song title, artist, and album information. Optionally, in step 36, the user's geographic location could also be determined, for use in obtaining information about content. In step 38, the time of the request for information is stored (timestamped). Then, in step 40, the radio station's playlist (stored in a database 42 of the radio station's music server 28) is queried for information about content which corresponds to the timestamped information. Thus, for example, if the end user 18 calls the server 12 at 12:35 PM on a given day to request information about a broadcasted song, this timestamp is used to query the database 42 of the music server 28 to obtain song title, artist, and/or album information corresponding to a song played by the radio station 16 at that time (i.e., at 12:35 PM). If geographic location information is determined in optional step 36, this information could also be used to query the database 42 for information about a song.

In step 44, a determination is made as to whether information matching the stored time is located in the database 42. If a negative determination is made, step 40 is repeated. Otherwise, step 46 occurs, wherein the song title, artist name, or album information obtained from the database 42 is processed into an appropriate format (e.g., into HTML format, or into a format suitable for transmission as a text message to the end-user's cellular telephone) and then transmitted to the end user. The end user is thus provided with real-time information about content being broadcasted by a radio station, using the end user's personal cellular telephone, portable communications device, or computer.

It is noted that if a cellular telephone is utilized by the end user to issue a request for information about content, the user's unique caller identifier (e.g., telephone number) could be used to “tag” the content, such that the obtained information about the content could be stored in an account associated with the caller (which could be stored in the server 12). This information could be used to build a playlist for the user, which could be subsequently accessed by the user as desired. Also, if the user does not wish, or is unable, to store the information about content transmitted to the user, such information could be later accessed by the user since it is tagged and stored at the server 12.

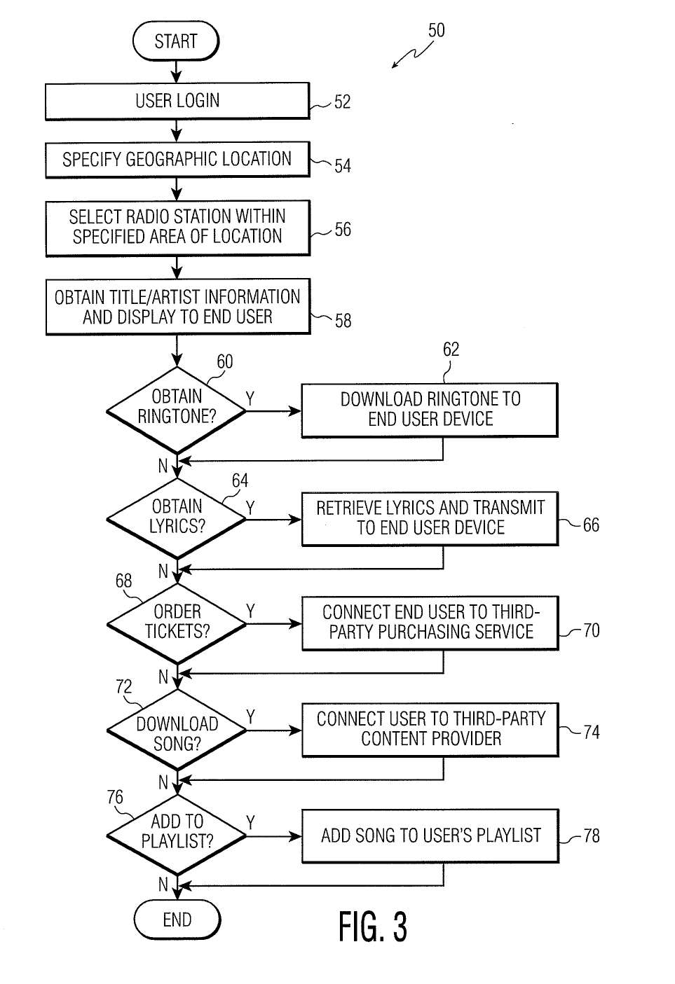

FIG. 3 is a flowchart showing processing steps, indicated generally at 50, according to the present invention for handling a web-based request for information about content. The processing steps 50 could be embodied as one or more software programs/modules which are programmed into the server 12. Such programs/modules could provide end user 18 with a series of HTML web pages accessible by the end user's computer. Such web-based requests could be accessed using any of the devices discussed above in connection with the user 18, such as the user's cellular telephone/personal communications device 20, and/or the user's local computer 20.

In step 52, the user logs into the server 12. This could be way of an account name and password login sequence, or simply by the end user directing his or her web browser to a URL associated with the server 12. In step 54, the user is provided with a web page wherein the user specifies his or her geographic location. This information could include the user's state, municipality, or combination thereof. In step 56, the user is provided with a list of radio stations within a pre-defined area of the user's location (e.g., 100 miles), and the user selects one of the radio stations (which could be the radio station that the user is currently listening to). In step 58, information about content currently being broadcasted by the selected radio station is obtained, and provided to the user by way of a customized web page. This information could be obtained using the steps shown in FIG. 2 and discussed above, i.e., by storing (stamping) the time of the user's request for information, and by querying the radio station's music server using the stamped time to locate matching information about content being broadcasted by the radio station.

Once the information about the content is provided to the user, a variety of options could be presented to the user. For example, in step 60, a determination is made as to whether the user desires to download a ring tone for the user's cellular telephone, which could be a rendition of the content or a portion of the content itself. If so, step 62 occurs, wherein the user could be directed to a website for downloading the ring tone to the user's cellular device (e.g., a website hosted by the user's cellular telephone carrier). Such a feature could also be provided by the server 12, in conjunction with the user's cellular provider. Also, as shown in step 64, a determination is made as to whether the user wishes to obtain lyrics corresponding to the broadcasted content. If so, the lyrics are retrieved (they could be stored at the server 12, or at some other location) and transmitted to the end user's device in step 66. In step 68, a determination is made as to whether the user wishes to order tickets for an event associated with an artist currently being broadcasted. If so, in step 70, the user is connected to a third-party ticket purchasing server (e.g., TICKETMASTER, etc.) so that the user can purchase tickets. In step 72, a determination is made as to whether the user wishes to download a copy of a song currently being broadcasted by the radio station. If so, in step 74, the user is directed to a third-party content provider (e.g., APPLE ITUNES, etc.) so that the user can download a copy of the song. In step 76, a determination is made as to whether the user wishes to add the currently broadcasted to his or her playlist (i.e., if the user wishes to “tag” the song). If so, step 78 occurs, wherein the song is added to the user's playlist.

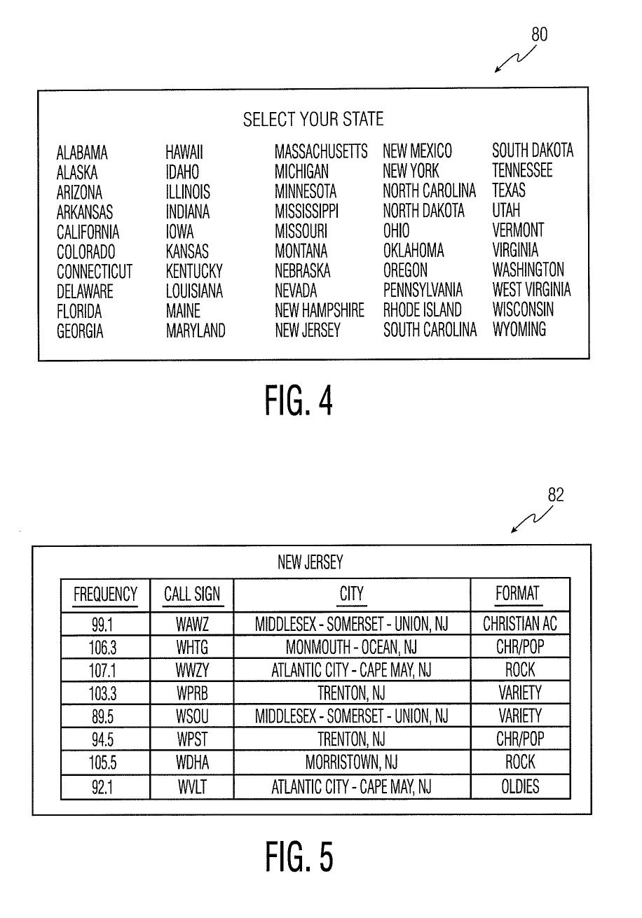

FIG. 4 is a screenshot showing a user interface screen (web page), indicated generally at 80, for allowing a user to identify his or her geographic location when requesting information about content currently being broadcasted by a radio station. As can be seen, the web page 80 provides the user with a list of states, one of which can be clicked by the user to select a desired state. Of course, other web page designs could be implemented, such as a text field for allowing the user to type in the user's location, or a map for allowing the user to click on a state/location depicted therein,

FIG. 5 is a screenshot showing another user interface screen (web page), indicated generally at 82, generated by the present invention for allowing a user to select a desired radio station within a pre-defined area of the user's location. As can be seen, the web page 82 lists each station's frequency, FCC callsign, city, and format, and the user can click on the desired radio station.

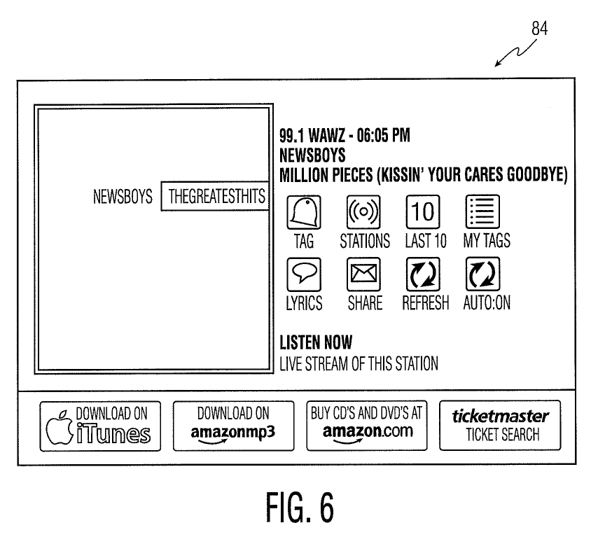

FIG. 6 is a screenshot showing another user interface screen (web page), indicated generally at 84, generated by the present invention for displaying information about content. The screen 84 is displayed in response to the user's selecting a link to a desired radio station, using the screen shown and discussed above in connection with FIG. 5. As can be seen, the screen displays the frequency and call sign of the radio station, as well as the time of the current radio broadcast, the artist name, and the song title. Optionally, as shown, a picture of the album corresponding to the song could also be displayed. The user can click on the “tag” button to add the song the user's playlist, the “stations” button to display the list of stations shown in FIG. 5, the “last 10” button to display the last 10 songs broadcasted by the selected radio station, the “my tags” button to see a list of songs currently in the user's playlist, the “lyrics” button to obtain a copy of the song's lyrics, the “share” button to e-mail information about the song to another person, the “refresh” button to refresh the screen 84 so that it displays current information about the song currently being played by the radio station, and the “Auto:on” button which configures the web page to automatically refresh whenever there is a change in content broadcasted by the radio station.

As can also be seen, the user can click on the “Listen Now” link to connect to the radio station's live streaming service (if provided), so that the user can listen to a streamed broadcast of the song through the Internet (i.e., at the user's personal computer). Also, as can be seen, the user can click on one or more third-party content provider links (e.g., ITUNES, AMAZON MP3, etc.) to download a copy of the song, or on a link to a third-party ticket provider (e.g., TICKETMASTER) to purchase tickets to an event.

It is noted that the present invention can handle requests for information about content other than songs broadcasted by radio stations. For example, a listener of a radio station can connected to the present invention (in the manners discussed herein, i.e., using a cellular telephone, portable communications device, or a local computer) when an advertisement is being broadcasted by a radio station or television station, whereupon the present invention timestamps the request and obtains information about the advertisement from one or more servers associated with a radio or television station, and conveys the information to the listener. The information obtained could include special offers relating to the advertisement, such as local discounts, special sales events, etc. Also, the present invention could be utilized in connection with obtaining information about video content being broadcasted by a televisions station, such as the name of a television program currently being broadcasted, information about a music video being broadcasted, etc. Similar to the steps for handling other types of content, a request for information about video content would be timestamped by the synchronization server, and information about the video content could be obtained from one or more servers associated with the broadcasting entity using the timestamp information.

As discussed above, the present invention can provide a caller with information about content being broadcasted by an entity in response to a telephone call to the synchronization server. It is noted that the server could automatically create a user account (identified by the caller identification number), password, and a playlist in response to a telephone call. For example, if a person calls the server of the present invention for the first time to obtain information about broadcasted content, the synchronization server can automatically create a user account (e.g., wherein the login identifier is the user's telephone number), a password, and a playlist which includes the information sought by the caller. A text message could then be transmitted to the caller, which informs the caller of the automatically-created user account and password, as well as the information about the broadcasted content. Using this information, the caller can then log into the sychrnonization server at any time in the future to obtain desired information, and does not have to go through the process of creating a user account and password. The caller's telephone number thus becomes a powerful piece of information for automatically creating an account and for logging into the account in the future.

Having thus described the invention in detail, it is to be understood that the foregoing description is not intended to limit the spirit or scope thereof. What is desired to be protected is set forth in the following claims.

What is claimed is:

1. A system for providing information about broadcasted content, comprising:
a server for receiving a request from a listener about content being broadcasted by a broadcasting entity;
means for generating a timestamp for the request, the timestamp representing the time of generation of the request by the listener;
means for querying a music database associated with the broadcasting entity using the timestamp to obtain information about content broadcasted by the broadcasting entity; and
means for transmitting the information to the listener.

2. The system of claim 2, further comprising means for obtaining location information about the listener's geographic location.

3. The system of claim 2, the means for querying the music database queries the music database for the information using the location information.

4. The system of claim 1, wherein the server receives a telephonic request for information about content generated by the listener calling a telephone number associated with the broadcasting entity.

5. The system of claim 4, wherein the server stores caller identifier information associated with the telephonic request and associates the caller identifier information with the information about the content to create a playlist for the listener.

6. The system of claim 4, wherein the means for transmitting the information to the listener transmits the information as a text message to the listener.

7. The system of claim 4, wherein the means for transmitting the information to the listener audibly conveys the information to the listener using Interactive Voice Response software.

8. The system of claim 1, wherein the server generates one or more web pages for receiving requests for information about content from the listener.

9. The system of claim 8, wherein the one or more web pages displays the information about the content to the listener.

10. The system of claim 9, wherein the one or more web pages includes a link for allowing the listener to download a ring tone associated with the broadcasted content.

11. The system of claim 9, wherein the one or more web pages includes a link for allowing the listener to add the broadcasted content to a playlist.

12. The system of claim 9, wherein the one or more web pages includes a link for allowing the listener to obtain lyrics associated with the broadcasted content.

13. The system of claim 9, wherein the one or more web pages includes a link for allowing the listener to purchase tickets to an event associated with the broadcasted content.

14. The system of claim 9, wherein the one or more web pages includes a link for allowing the listener to download a copy of the broadcasted content.

15. The system of claim 9, wherein the one or more web pages includes a link for allowing the listener to share information about the broadcasted content with another individual.

16. The system of claim 9, wherein the one or more web pages includes a link for allowing the listener to access a streamed version of the broadcasted content.

17. The system of claim 9, wherein the one or more web pages allows the user to specify location information.

18. The system of claim 17, wherein the means for querying the music database queries the music database for the information using the location information.

19. A method for providing information about broadcasted content, comprising the steps of:
receiving a request at a server from a listener about content being broadcasted by a broadcasting entity;
generating a timestamp for the request, the timestamp representing the time of generation of the request by the listener;
querying a music database associated with the broadcasting entity using the timestamp to obtain information about content broadcasted by the broadcasting entity; and
transmitting the information to the listener.

20. The method of claim 19, further comprising obtaining location information about the listener's geographic location.

21. The method of claim 20, further comprising querying the music database using the location information.

22. The method of claim 19, further comprising receiving at the server a telephonic request for information about content generated by the listener calling a telephone number associated with the broadcasting entity.

23. The method of claim 22, further comprising storing caller identifier information associated with the telephonic request and associating the caller identifier information with the information about the content to create a playlist for the listener.

24. The method of claim 22, further comprising transmitting the information to the listener as a text messenger.

25. The method of claim 22, further comprising audibly conveying the information to the listener using Interactive Voice Response software.

26. The method of claim 19, further comprising generating one or more web pages for receiving requests for information about content from the listener.

27. The method of claim 26, further comprising displaying the information about the content to the listener using the one or more web pages.

28. The method of claim 26, further comprising including a link in the one or more web pages for allowing the listener to download a ring tone associated with the broadcasted content.

29. The method of claim 26, further comprising including a link in the one or more web pages for allowing the listener to add the broadcasted content to a playlist.

30. The method of claim 26, further comprising including a link in the one or more web pages for allowing the listener to obtain lyrics associated with the broadcasted content.

31. The method of claim 26, further comprising including a link in the one or more web pages for allowing the listener to purchase tickets to an event associated with the broadcasted content.

32. The method of claim 26, further comprising including a link in the one or more web pages for allowing the listener to download a copy of the broadcasted content.

33. The method of claim 26, further comprising including a link in the one or more web pages for allowing the listener to share information about the broadcasted content with another individual.

34. The method of claim 26, further comprising including a link in the one or more web pages for allowing the listener to access a streamed version of the broadcasted content.

35. The method of claim 26, further comprising allowing the user to specify location information using the one or more web pages.

36. The method of claim 35, wherein further comprising querying the music database using the location information.

37. A method for providing information about broadcasted content, comprising the steps of:
receiving a telephone call at a server from a listener requesting information about content being broadcasted by a broadcasting entity;
obtaining caller identification information corresponding to the telephone call;
querying a database associated with the broadcasting entity to obtain information about content broadcasted by the broadcasting entity;
transmitting the information about the content to the listener; and
storing the caller identification information at the server for future use in obtaining the information about the content.

38. The method of claim 37, further comprising creating a user account at the server identified by the caller identification information.

39. The method of claim 38, further comprising creating a password at the server associated with the user account.

40. The method of claim 39, further comprising transmitting information about the user account and password to the caller.

41. The method of claim 40, further comprising transmitting the information about the user account and password to the caller in a text message.
